(19) United States
(12) Patent Application Publication
(10) Pub. No.: US 2025/0331626 A1
(43) Pub. Date: Oct. 30, 2025

(54) DEVICE STORAGE CARRYING BAG

(71) Applicant: Ting Li, Gaozhou (CN)

(72) Inventor: Ting Li, Gaozhou (CN)

(21) Appl. No.: 19/263,585

(22) Filed: Jul. 9, 2025

(30) Foreign Application Priority Data
Jun. 20, 2025 (CN) 202521280247.3

(51) Int. Cl. A45F 3/00; A45F 3/14; F16M 13/04

(52) U.S. Cl. CPC A45F 3/005; A45F 3/14; F16M 13/04; A45F 2003/144

(57) ABSTRACT

A device storage carrying bag is provided, including a flexible bag body and a body wearing component. A plurality of first connectors and a plurality of second connectors are disposed on the bag body. When the bag body is in a spreading form, the first connector and the second connector are respectively located on two sides of the bag body. The device storage carrying bag can spread so as to facilitate to wrap a device. In addition, the flexible bag body can be folded or rolled, so that the volume can be reduced to facilitate storage. A design of a wire winding belt avoids the device from being wound during use, and also can avoid from causing connection between a wire and the device to be affected when the wire is pulled.

### TECHNICAL FIELD

The present disclosure relates to the field of storage carrying bag technologies, and in particular, to a device storage carrying bag.

### BACKGROUND

In daily life, a broom is usually used to clean the ground. With rapid development of science and technology, a vacuum cleaner emerges, which not only reduces human costs of cleaning, but also improves cleaning efficiency. The vacuum cleaner is an indispensable cleaning tool in modern society, and is widely used in commercial buildings, public places, manufacturing workshops, hotels, medical and sanitary facilities, retail services, gymnasiums, and other places. The vacuum cleaner is a device that generates negative pressure inside the vacuum cleaner by rotating at a high speed through blades of a motor, so as to absorb dust.

Currently, for a relatively heavy horizontal vacuum cleaner, arm force is usually required to carry and drag the vacuum cleaner. Operations are cumbersome and easy to fatigue, resulting in poor user experience.

### SUMMARY

The present disclosure aims to overcome disadvantages and shortages in the prior art, and provides a device storage carrying bag.

One embodiment of the present disclosure provides a device storage carrying bag, including a flexible bag body and a body wearing component.

A plurality of first connectors and a plurality of second connectors are disposed on the bag body.

The body wearing component is disposed on the bag body.

The bag body is able to be switched to a storage carrying bag form and a spreading form by changing a shape of the bag body.

When the bag body is in the spreading form, the first connector and the second connector are respectively located on two sides of the bag body.

When the bag body is in the storage carrying bag form, the first connector is detachably in locking fit with the second connector. The bag body, the first connector, and the second connector are surrounded to form storage carrying bag space. The storage carrying bag space is used to wrap a device. The bag body is located at the bottom, in the front, and in the rear of the storage carrying bag space. The first connector and/or the second connector are/is disposed at least at the top of the storage carrying bag space.

In some optional implementations, the body wearing component is a waistband component, a strap component, or a sling component.

In some optional implementations, a functional connector is disposed on the bag body, and the body wearing component detachably fits with the bag body by using the functional connector.

In some optional implementations, when the body wearing component is the waistband component, two ends of the waistband component are connected by using a tightness adjusting structure, and the tightness adjusting structure is able to drive the two ends of the waistband component to get close to or away from each other.

In some optional implementations, when the body wearing component is the waistband component, the functional connector includes two first connection buckles. The first connection buckle is disposed on the bag body. The two first connection buckles are respectively disposed on two sides that are of the bag body and that are located on a part in the front of the storage carrying bag space. The waistband component is located in the rear of the storage carrying bag space. Waistband connection buckles are respectively disposed on two sides of the waistband component. The waistband connection buckle is correspondingly in lock-buckle fit with to the first connection buckle.

In some optional implementations, when the body wearing component is the waistband component, the functional connector is a magic tape connection surface disposed in the front of the storage carrying bag space. A side belt is disposed on the waistband component. The waistband component is located in the rear of the storage carrying bag space. A magic tape fitting part is disposed on the side belt. The side belt is wound to the front of the storage carrying bag space from the waistband component and then detachably connected to the magic tape connection surface by using the magic tape fitting part.

In some optional implementations, when the body wearing component is the sling component, sling connectors are respectively disposed at two ends of the sling component. The functional connector includes two second connection buckles. The two second connection buckles are disposed on the bag body and are respectively located on the front and the rear of the storage carrying bag space. The sling connector is correspondingly in lock-buckle fit with the second connection buckle.

In some optional implementations, the sling connector includes a first sling connection buckle and a second sling connection buckle that are connected to each other. The first sling connection buckle is detachably connected to an end of the sling component. The second sling connection buckle is detachably connected to the second connector.

In some optional implementations, the device storage carrying bag further includes a wire winding belt. A wire winding part and a connecting part are formed on the wire winding belt. The connecting part is configured to be detachably connected to the device. The wire winding part is configured to wind a wire of the device.

In some optional implementations, the first connector is a magic tape belt. The second connector is a buckle ring. One part of the magic tape belt passes through the buckle ring and then is detachably bonded with the other part of the magic tape belt.

Compared with the prior art, the device storage carrying bag can spread so as to facilitate to wrap the device. Quick assembling can be achieved by using designs of the first connector and the second connector to wrap the device. In addition, the device storage carrying bag is worn in various forms, which meets different requirements of a user. In addition, the flexible bag body can be folded or rolled, so that the volume can be reduced to facilitate storage. A design of the wire winding belt avoids the device from being wound during use, and also can avoid from causing connection between the wire and the device to be affected when the wire is pulled.

To understand the present disclosure more clearly, specific implementations of the present disclosure are described with reference to attached figures.

### BRIEF DESCRIPTION OF THE DRAWINGS

FIG. 1 is a schematic structural diagram of a device storage carrying bag when a bag body is in a storage carrying bag form according to one embodiment of the present disclosure;

FIG. 2 is a schematic structural diagram of a device storage carrying bag when a bag body is in a spreading form according to one embodiment of the present disclosure;

FIG. 3 is a schematic structural diagram of a device and a device storage carrying bag when a bag body is in a storage carrying bag form according to one embodiment of the present disclosure;

FIG. 4 is a schematic structural diagram of a device and a device storage carrying bag when a bag body and a body wearing component are separated according to one embodiment of the present disclosure;

FIG. 5 is a schematic structural diagram of a device and a device storage carrying bag when a bag body is in a storage carrying bag form according to another embodiment of the present disclosure;

FIG. 6 is a schematic structural diagram of a device and a device storage carrying bag when a bag body and a body wearing component are separated according to another embodiment of the present disclosure;

FIG. 7 is an enlarged view of part A shown in FIG. 6; and

FIG. 8 is an enlarged view of part B shown in FIG. 3.

Reference signs in attached figures:

10: bag body; 11: first connector; 12: second connector; 13: functional connector; 131: first connection buckle; 132: second connection buckle; 14: storage bag; 20: body wearing component; 21: tightness adjusting structure; 22: waistband connection buckle; 221: connecting belt; 23: sling connector; 231: first sling connection buckle; 232: second sling connection buckle; 30: storage carrying bag space; 40: device; 50: wire winding belt; 51: wire winding part; and 52: connecting part.

### DETAILED DESCRIPTION OF THE EMBODIMENTS

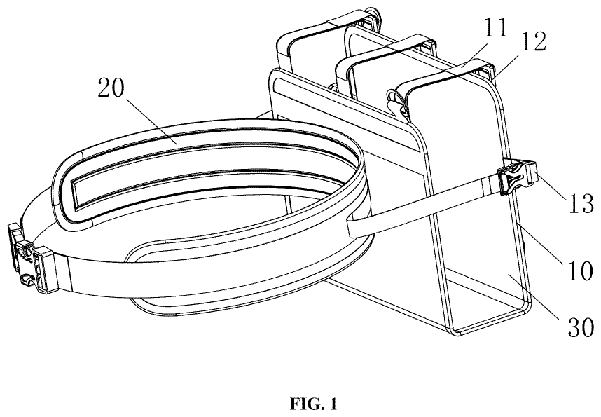

The following clearly and completely describes the technical solutions in the embodiments of the present disclosure with reference to the attached figures in the embodiments of the present disclosure. Referring to FIG. 1 to FIG. 3, one embodiment of the present disclosure provides a device storage carrying bag, including a flexible bag body 10 and a body wearing component 20.

The bag body 10 is made of a flexible material, so that the bag body 10 can be bent and folded so as to adapt to wrap different shapes of a device 40, and can also be folded or wound by itself, thereby facilitating storage. For a preparation material of the bag body 10, a proper design may be selected based on an actual requirement. In one embodiment, the bag body 10 may be prepared by using cloth made of different materials. For example, the bag body 10 may be made of a material such as nylon cloth, linen cloth, and oxford cloth.

A plurality of first connectors 11 and a plurality of second connectors 12 are disposed on the bag body 10. For quantities of the first connectors 11 and the second connectors 12, only one first connector 11 and only one second connector 12 may be disposed, and a plurality of first connector 11 and a plurality of second connector 12 may alternatively be disposed. In addition, one first connector 11 may be connected to a plurality of second connectors 12, or one second connector 12 is connected to a plurality of first connector 11, or the first connector 11 is connected to the second connector 12 in one-to-one correspondence.

The body wearing component 20 is disposed on the bag body 10, and the body wearing component is mainly configured to wear on a body, so that the body carries the bag body 10 by using the body wearing component.

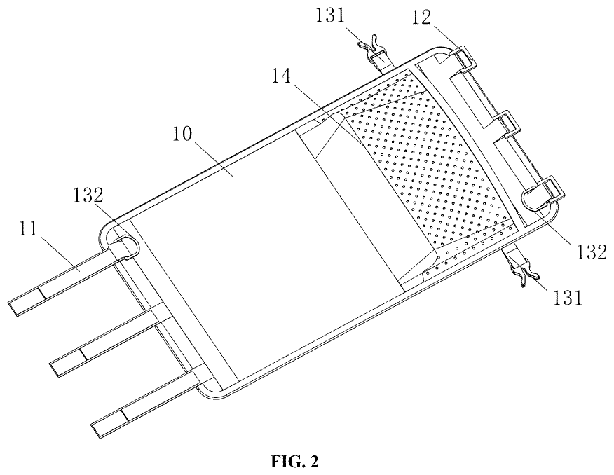

The bag body 10 is able to be switched to a storage carrying bag form and a spreading form by changing a shape of the bag body. When the bag body 10 is in the spreading form, the first connector 11 and the second connector 12 are respectively located on two sides of the bag body 10 (as shown in FIG. 2). In this case, the device 40 is conveniently placed on the bag body 10, so as to facilitate the bag body 10 to be switched to the storage carrying bag form subsequently. Specifically, when in the spreading form, the bag body 10 may be divided into a front area, a middle area, and a rear area in sequence. The device is placed in the middle area of the bag body 10. A size of the middle area of the bag body 10 fits with a size of the device. The front area of the bag body 10 is wound to the front of the device. The rear area of the bag body 10 is wound to the rear of the device. Then, the first connector 11 and the second connector 12 are wound to the top of the device. Then, the first connector 11 and the second connector 12 are connected to each other, so that the bag body 10 is in the storage carrying bag form. When the bag body 10 is in the storage carrying bag form, the first connector 11 is detachably in locking fit with the second connector 12. The bag body 10, the first connector 11, and the second connector 12 are surrounded to form storage carrying bag space 30. The storage carrying bag space 30 is used to wrap the device 40. The front area of the bag body 10 is located in the front of the storage carrying bag space 30. The rear area of the bag body 10 is located in the rear of the storage carrying bag space 30. The middle area of the bag body 10 is located at the bottom of the storage carrying bag space 30. The first connector 11 and/or the second connector 12 are/is disposed at least on the top of the storage carrying bag space 30 (as shown in FIG. 1).

The following describes the working principle of the device storage carrying bag according to one embodiment of the present disclosure.

When the device 40 needs to be carried on the back, the bag body 10 is first switched to the spreading form. In this case, the bag body 10 is in a flattening state, the bottom of the bag body 10 may be placed in the middle area of the bag body 10, and then one side that is of the bag body 10 and that has the first connector 11 and one side that is of the bag body 10 and that has the second connector 12 are lifted up. Then, the front area of the bag body 10 and the rear area of the bag body 10 are respectively folded along a side line at the bottom of the device 10 and then abut against the front and the rear of the device 10, and the first connector 11 and the second connector 12 are connected, so that the bag body 10 keeps a state of wrapping the device 40. In this case, the bag body 10 is limited in the front, in the rear, and at the bottom of the device 40. However, the first connector 11 and/or the second connector 12 limit/limits the device 40 on the top of the device 40, so that the device 40 is limited in the storage carrying bag space 30.

A person carries the bag body 10 on the body by using the body wearing component, so that it is convenient to enable both hands to be free while the device 40 is carried, so as to facilitate another operation. For example, when the device 40 is a vacuum cleaner, the user may place a body of the vacuum cleaner in the storage carrying bag space 30, and the user may perform a dust suction operation by holding a suction head of the vacuum cleaner. During movement, the body of the vacuum cleaner does not need to be manually carried, and operation is convenient. It should be noted that in the present disclosure, the device 40 is not limited to a vacuum cleaner, and the device 40 may alternatively be another device 40 except a vacuum cleaner, such as a storage battery apparatus, a water tank apparatus, or the like.

For a structure of the body wearing component 20, a proper design may be selected based on an actual requirement. For example, in some optional implementations, the body wearing component 20 is a waistband component, a strap component, or a sling component.

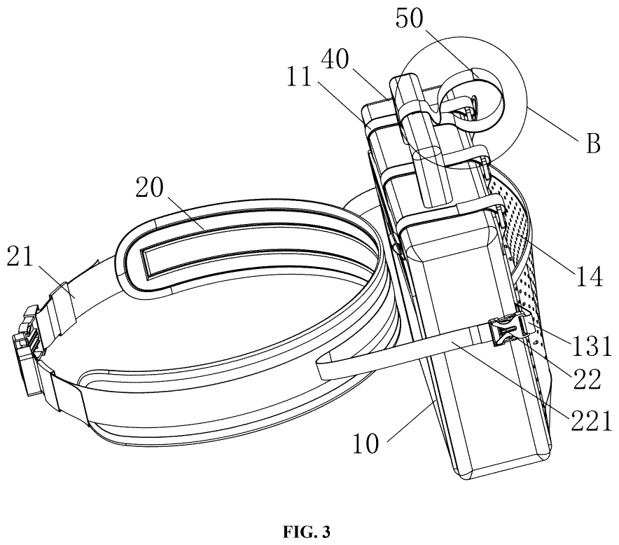

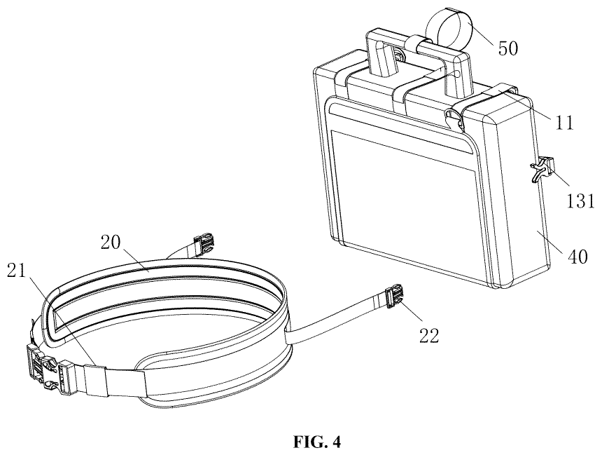

Referring to FIG. 1, FIG. 3, and FIG. 4, the body wearing component 20 shown in FIG. 1, FIG. 3, and FIG. 4 is a waistband component. When the body wearing component 20 is the waistband component, a position suitable for use may be selected based on an actual situation, so that the waistband component is installed on the bag body 10. The waistband component may be bound to a waist of the body, so as to implement wearing. A structure of the waistband component may be designed based on an actual requirement. For example, the waistband component may be a waist band around the body. This is not limited thereto.

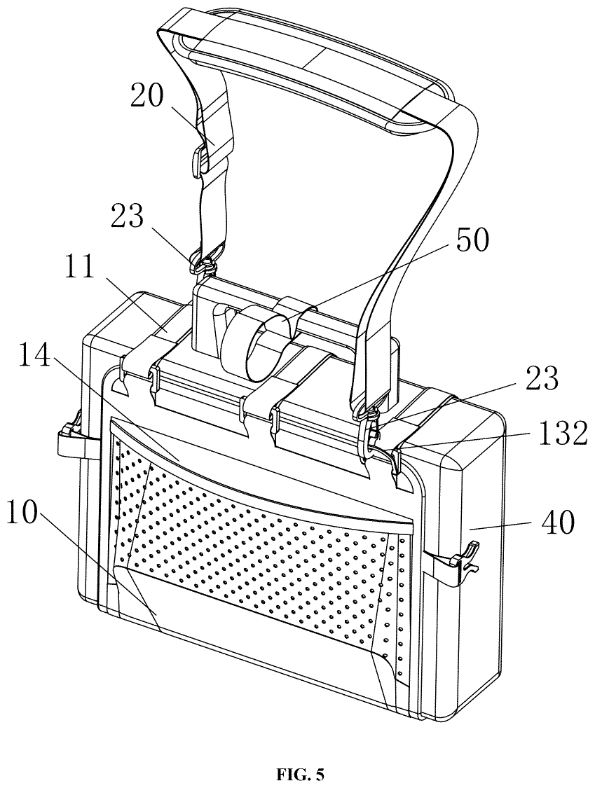

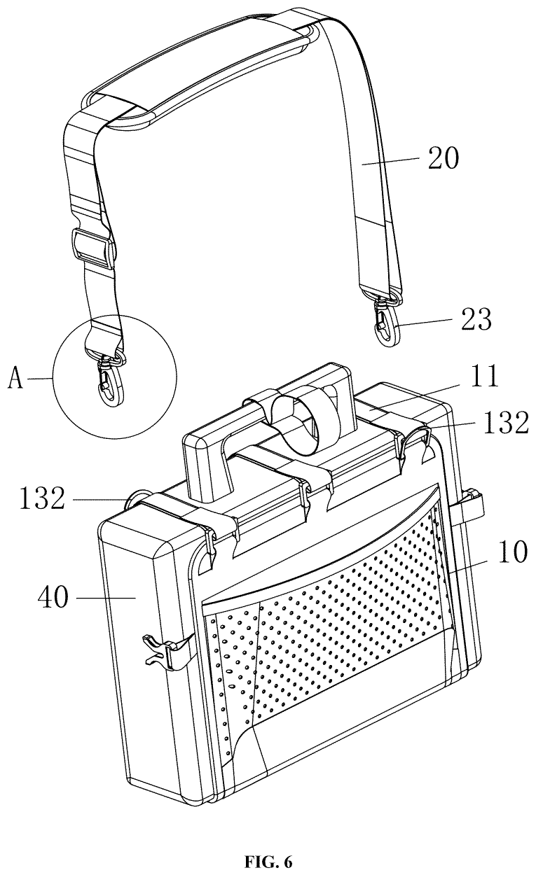

Referring to FIG. 5 and FIG. 6, the body wearing component 20 shown in FIG. 5 and FIG. 6 is a sling component. When the body wearing component 20 is the sling component, two ends of the cling component are connected to the bag body 10, and the cling component may bypass the body from a shoulder and a waist side, thereby implementing wearing. A structure of the cling component may be designed based on an actual requirement. For example, a soft cushion laminated to the shoulder of the body is disposed on the cling component, thereby improving the comfort. This is not limited thereto.

When the body wearing component 20 is the strap component, the strap component may select, based on an actual situation, a position suitable for use, so as to be installed on the bag body 10, and the strap component is wound to the shoulder of the body. A structure of the strap component may be designed based on an actual requirement. For example, the strap component includes two straps. Two ends of the strap are detachably connected to the bag body 10. The two straps may be disposed on two sides of the storage carrying bag space 30, and are correspondingly worn in combination with shoulders on two sides of the body.

Certainly, a structure of the body wearing component 20 is not limited thereto. A person skilled in the art may also select another suitable structure based on teachings of the present disclosure.

In some optional implementations, a functional connector 13 is disposed on the bag body 10, and the body wearing component 20 detachably fits with the bag body 10 by using the functional connector 13. When the device 40 does not need to be carried, the body wearing component may be detached from the bag body 10 to facilitate to store the bag body 10 and the body wearing component. For a specific structure of the functional connector 13, a proper design may be selected based on an actual requirement. For example, the functional connector 13 is a hook surface of a magic tape or a rough surface of a magic tape, and the hook surface of a magic tape or the rough surface of a magic tape is correspondingly disposed on the body wearing component 20. The rough surface of a magic tape and the hook surface of a magic tape are bonded to each other, so that detachable fastening of the body wearing component is implemented. Or, the functional connector 13 is a lock buckle, a buckle ring is disposed on the body wearing component, and the lock buckle detachably fits with the buckle ring, so as to implement detachable fastening of the body wearing component. This is not limited thereto.

It should be noted that, in a case that the body wearing component 20 is detachably connected to the bag body 10, a plurality of different body wearing components 20 may be prepared in advance. For example, at least two of the waistband component, the strap component, and the cling component are prepared in advance. Subsequently, one of the body wearing components 20 may be selected based on an actual situation and assembled on the bag body 10, so as to adapt to different use requirements.

In some optional implementations, when the body wearing component 20 is the waistband component, two ends of the waistband component are connected by using a tightness adjusting structure 21, and the tightness adjusting structure 21 is able to drive the two ends of the waistband component to get close to or away from each other. For a specific structure of the tightness adjusting structure 21, a proper design may be selected based on an actual requirement. For example, the tightness adjusting structure 21 may be an elastic band with elasticity. Two ends of the elastic band are respectively connected to two ends of the waistband component. The elastic band and the waistband component are jointly surrounded to form space for tightening the waist. Because the elastic ban is elastic and can be stretched, deformation can be correspondingly generated based on a size of the waist, so as to adapt to persons of different types. Certainly, the tightness adjusting structure 21 may alternatively include an adjusting buckle and an adjusting belt. The adjusting buckle is disposed at one end of the waistband component, and the adjusting belt is disposed at the other end of the waistband component. A part that is of the adjusting belt and that is located between a root of the adjusting belt and the adjusting buckle can be surrounded together with the waistband component to form space for fastening the waist. By adjusting the adjusting belt to bypass the adjusting buckle, a spacing between the root of the adjusting belt and the adjusting buckle is adjusted, thereby adjusting a size of the space for fastening the waist, and achieving a purpose of adjusting tightness.

In some optional implementations, when the body wearing component 20 is the waistband component, the functional connector 13 includes two first connection buckles 131. The first connection buckle 131 is disposed on the bag body 10. The two first connection buckles 131 are respectively disposed on two sides that are of the bag body 10 and that are located on a part in the front of the storage carrying bag space 30. The waistband component is located in the rear of the storage carrying bag space 30. Waistband connection buckles 22 are respectively disposed on two sides of the waistband component. The waistband connection buckle 22 is correspondingly in lock-buckle fit with to the first connection buckle 131. In this implementation, a connecting belt 221 is disposed in the rear of the waistband component. The waistband connection buckles 22 are disposed at the two ends of the connecting belt 221. The connecting belt 221 may be wound to left and right sides of the storage carrying bag space 30, thereby limiting a location of the device on the left and right sides of the storage carrying bag space 30, and preventing the device from being separated from the storage carrying bag space 30 on the left and right sides of the storage carrying bag space 30.

For specific structures of the waistband connection buckle 22 and the first connection buckle 131, proper designs may be selected based on an actual requirement. For example, in one embodiment, the waistband connection buckle 22 is a lock buckle, and the first connection buckle 131 is a structure that can fit with the lock buckle. Or, the first connection buckle 131 is a lock buckle, and the waistband connection buckle 22 is a structure that can fit with the lock buckle. In another embodiment, the waistband connection buckle 22 is an insertion buckle, and the first connection buckle 131 is a structure that can fit with the insertion buckle. Or, the first connection buckle 131 is an insertion buckle, and the waistband connection buckle 22 is a structure that can fit with the insertion buckle. In another embodiment, the waistband connection buckle 22 is a buckle, and the first connection buckle 131 is a structure that can fit with the buckle. Or, the first connection buckle 131 is a buckle, and the waistband connection buckle 22 is a structure that can fit with the buckle.

Certainly, the waistband component may alternatively be detachably installed on the bag body 10 in other proper manners. For example, in some other optional implementations, the functional connector 13 is a magic tape connection surface disposed in the front of the storage carrying bag space 30. A side belt is disposed on the waistband component. The waistband component is located in the rear of the storage carrying bag space 30. A magic tape fitting part is disposed on the side belt. The side belt is wound to the front of the storage carrying bag space 30 from the waistband component and then detachably connected to the magic tape connection surface by using the magic tape fitting part. The side belt implements fastening of a position by using cooperation between the magic tape fitting part and the magic tape connection surface, and then the waistband component is detachably fastened to the bag body 10.

In some optional implementations, when the body wearing component 20 is the sling component, sling connectors 23 are respectively disposed at two ends of the sling component. The functional connector 13 includes two second connection buckles 132. The two second connection buckles 132 are disposed on the bag body 10 and are respectively located in the front and the rear of the storage carrying bag space 30. The sling connector 23 is correspondingly in lock-buckle fit with the second connection buckle 132. The sling component can be connected to a part that is of the bag body 10 and that is located in the front of the storage carrying bag space 30 and a part that is of the bag body 10 and that is located in the rear of the storage carrying bag space 30, so that the stress of the bag body is relatively balanced, so as to stably support the device 40 and reduce shaking of the device 40.

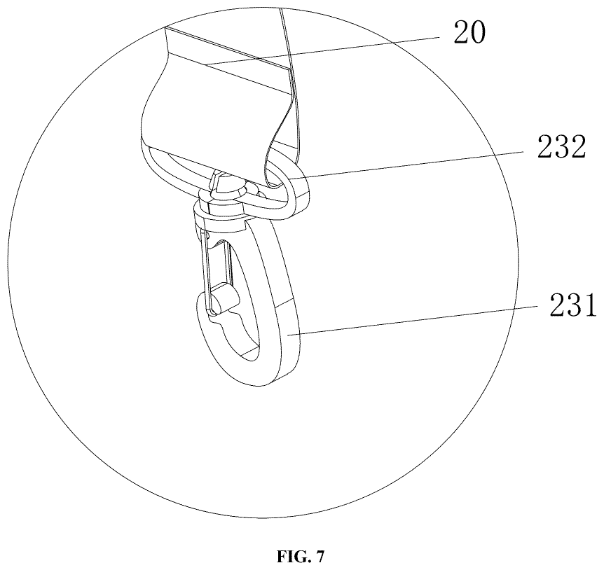

Referring to FIG. 7, in some optional implementations, the sling connector 23 includes a first sling connection buckle 231 and a second sling connection buckle 232 that are connected to each other. The first sling connection buckle 231 is detachably connected to an end of the sling component. The second sling connection buckle 232 is detachably connected to the second connector 12. The first sling connection buckle 231 and the second sling connection buckle 232 may be disposed integrally, and may alternatively be detachably connected to each other. Certainly, the belt sling connector 23 may also be another proper structure, which is not limited thereto.

For specific structures of the first sling connection buckle 231 and the second connection buckle 132, proper designs may be selected based on an actual requirement. For example, in one embodiment, the first sling connection buckle 231 is a lock buckle, and the second connection buckle 132 is a structure that can fit with the lock buckle. Or, the second connection buckle 132 is a lock buckle, and the first sling connection buckle 231 is a structure that can fit with the lock buckle. In another embodiment, the first sling connection buckle 231 is an insertion buckle, and the second connection buckle 132 is a structure that can fit with the insertion buckle. Or, the second connection buckle 132 is an insertion buckle, and the first sling connection buckle 231 is a structure that can fit with the insertion buckle. In another embodiment, the first sling connection buckle 231 is a buckle, and the second connection buckle 132 is a structure that can fit with the buckle. Or, the second connection buckle 132 is a buckle, and the first sling connection buckle 231 is a structure that can fit with the buckle. In this implementation, the first sling connection buckle 231 is a hook buckle, and the second connection buckle 132 is a buckle ring.

For a specific structure of the second sling connection buckle 232, a proper design may be selected based on an actual requirement. For example, in one embodiment, the second sling connection buckle 232 is a buckle ring. A magic tape belt is disposed on the sling component. The magic tape belt passes through the buckle ring and then is bonded to the second sling connection buckle 232, thereby implementing a connection between the sling component and the second sling connection buckle 232. Alternatively, in another embodiment, the second sling connection buckle 232 is a lock buckle, and a structure that can detachably fit with the lock buckle is disposed on the sling component.

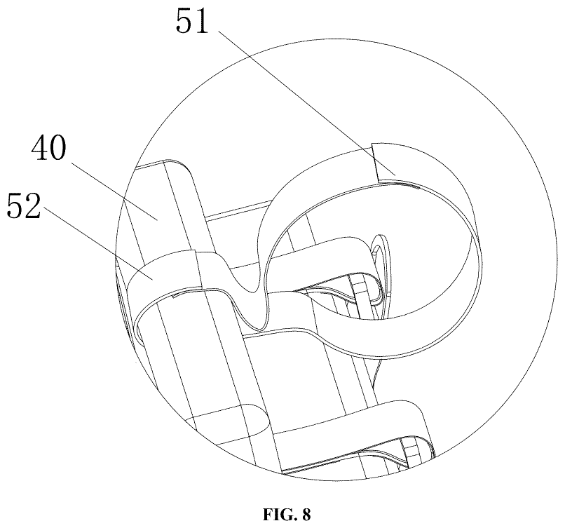

Referring to FIG. 8, in some optional implementations, the device storage carrying bag further includes a wire winding belt 50. A wire winding part 51 and a connecting part 52 are formed on the wire winding belt 50. The connecting part 52 is configured to be detachably connected to the device 40. The wire winding part 51 is configured to wind a wire of the device 40. The user needs to carry the device 40 on the back to move, and the device 40 is usually connected to the wire. In addition, the wire is usually relatively long. Therefore, a wire winding belt 50 is additionally disposed, so that the wire can be wound on the wire winding part 51, so as to avoid the wire from being scattered or entangled to another structure. In this embodiment, the wire winding belt 50 is a magic tape belt, and the wire winding belt 50 may be wound and bonded by itself to form two ring structures. The two ring structures are respectively the wire winding part 51 and the connecting part 52. The connecting part 52 may be sleeved on the device 40 or on the bag body 10, and the wire may pass through the wire winding part 51 and then be wound on the wire winding part 51. In addition, the wire winding belt 50 may release bonding to be flattened, so as to be facilitate storage together with the bag body 10. This is not limited thereto.

For specific structures of the first connector 11 and the second connector 12, proper designs may be selected based on an actual requirement. For example, in one embodiment, the first connector 11 is a lock buckle, and the second connector 12 is a structure that can fit with the lock buckle. Or, the second connector 12 is a lock buckle, and the first connector 11 is a structure that can fit with the lock buckle. In another embodiment, the first connector 11 is an insertion buckle, and the second connector 12 is a structure that can fit with the insertion buckle. Or, the second connector 12 is an insertion buckle, and the first connector 11 is a structure that can fit with the insertion buckle. In another embodiment, the first connector 11 is a buckle, and the second connector 12 is a structure that can fit with the buckle. Or, the second connector 12 is a buckle, and the first connector 11 is a structure that can fit with the buckle. In another embodiment, both the first connector 11 and the second connector 12 are binding bands, and the first connector 11 and the second connector 12 may be detachably bound together. Or, one of the first connector 11 and the second connector 12 is a binding band, and the other is a binding ring. The binding band is detachably bound to the binding ring. In this embodiment, the first connector 11 is a magic tape belt. The second connector 12 is a buckle ring. One part of the magic tape belt passes through the buckle ring and then is detachably bonded with the other part of the magic tape belt.

In addition, a storage bag 14 is further disposed on the bag body 10. When the bag body 10 is in the storage carrying bag form, the storage bag 14 is located on a part that is of the bag body 10 and that is located in the rear of the storage carrying bag space 30, and the storage bag 14 facilitates to store an article.

Although the embodiments of the present disclosure have already been illustrated and described, various changes, modifications, replacements and transformations can be made by those skilled in the art under the condition of without departing from the principle and the spirit of the present disclosure, and thus the scope of the present disclosure should be restricted by claims and equivalents thereof.

What is claimed is:

1. A device storage carrying bag, comprising a flexible bag body and a body wearing component, wherein
a plurality of first connectors and a plurality of second connectors are disposed on the bag body;
the body wearing component is disposed on the bag body;
the bag body is able to be switched to a storage carrying bag form and a spreading form by changing a shape of the bag body;
when the bag body is in the spreading form, the first connector and the second connector are respectively located on two sides of the bag body; and
when the bag body is in the storage carrying bag form, the first connector is detachably in locking fit with the second connector, the bag body, the first connector, and the second connector are surrounded to form storage carrying bag space, the storage carrying bag space is used to wrap a device, the bag body is located at the bottom, in the front, and in the rear of the storage carrying bag space, and the first connector and/or the second connector are/is disposed at least at the top of the storage carrying bag space.

2. The device storage carrying bag according to claim 1, wherein the body wearing component is a waistband component, a strap component, or a sling component.

3. The device storage carrying bag according to claim 2, wherein a functional connector is disposed on the bag body, and the body wearing component detachably fits with the bag body by using the functional connector.

4. The device storage carrying bag according to claim 2, wherein when the body wearing component is the waistband component, two ends of the waistband component are connected by using a tightness adjusting structure, and the tightness adjusting structure is able to drive the two ends of the waistband component to get close to or away from each other.

5. The device storage carrying bag according to claim 3, wherein when the body wearing component is the waistband component, the functional connector comprises two first connection buckles, the first connection buckle is disposed on the bag body, the two first connection buckles are respectively disposed on two sides that are of the bag body and that are located on a part in the front of the storage carrying bag space, the waistband component is located in the rear of the storage carrying bag space, waistband connection buckles are respectively disposed on two sides of the waistband component, and the waistband connection buckle is correspondingly in lock-buckle fit with to the first connection buckle.

6. The device storage carrying bag space according to claim 3, wherein when the body wearing component is the waistband component, the functional connector is a magic tape connection surface disposed in the front of the storage carrying bag space, a side belt is disposed on the waistband component, the waistband component is located in the rear of the storage carrying bag space, a magic tape fitting part is disposed on the side belt, and the side belt is wound to the front of the storage carrying bag space from the waistband component and then detachably connected to the magic tape connection surface by using the magic tape fitting part.

7. The device storage carrying bag according to claim 3, wherein when the body wearing component is the sling component, sling connectors are respectively disposed at two ends of the sling component, the functional connector comprises two second connection buckles, the two second connection buckles are disposed on the bag body and are respectively located in the front and the rear of the storage carrying bag space, and the sling connector is correspondingly in lock-buckle fit with the second connection buckle.

8. The device storage carrying bag according to claim 7, wherein the sling connector comprises a first sling connection buckle and a second sling connection buckle that are connected to each other, the first sling connection buckle is detachably connected to an end of the sling component, and the second sling connection buckle is detachably connected to the second connector.

9. The device storage carrying bag according to claim 1, further comprising a wire winding belt, wherein a wire winding part and a connecting part are formed on the wire winding belt, the connecting part is configured to be detachably connected to the device, and the wire winding part is configured to wind a wire of the device.

10. The device storage carrying bag according to claim 9, wherein the first connector is a magic tape belt, the second connector is a buckle ring, and one part of the magic tape belt passes through the buckle ring and then is detachably bonded with the other part of the magic tape belt.
